(19) United States
(12) Patent Application Publication
(10) Pub. No.: US 2008/0207977 A1
(43) Pub. Date: Aug. 28, 2008

(54) 300-Year disposal solution for spent nuclear fuel

(76) Inventor: William D. Peterson, Salt Lake City, UT (US)

Correspondence Address: TRASK BRITT, P.O. BOX 2550, SALT LAKE CITY, UT, 84110, US

(21) Appl. No.: 11/899,209

(22) Filed: Sep. 4, 2007

Related U.S. Application Data
(63) Continuation-in-part of application No. 10/736,858, filed on Dec. 16, 2003, now abandoned.
(60) Provisional application No. 60/434,019, filed on Dec. 16, 2002.

(51) Int. Cl. G21F 9/00

(52) U.S. Cl. 588/3

(57) ABSTRACT

A method including a combination of intermediate storage and reprocessing is utilized to process spent nuclear fuel (SNF) and thereby effect a disposition of that SNF within a period of 300 years. The method includes five or more years of pool water storage wherein ninety-nine percent (%) of the fission wastes energy decays. The waste material is then stored in an air convention storage facility, before processing to separate Cesium and Strontium from the waste is effected. This air convection cooling may be done in convection air-cooled concrete casks. During 50 years of convection air-cooled storage the energy contained in the waste material declines another one half %. Thereafter, at any point the SNF is processed to sufficiently separate 99.999% of the 97% of actinides (approximately 95% U238 uranium, 1% U235 uranium, and 1% Pu239 plutonium) from the 3% fission wastes. Again, it is only necessary to provide approximately 99.999% separation of the TRU's (transuranic waste) from the fps (fission products)—more specifically, sufficient separation so that the residual fps are contaminated with less than 100 nCi/g TRU's, as defined in the Class C regulations—10CFR61. The separated actinides and transuranics are thereafter utilized in the manufacture of MOX (mixed oxide) or fast burner reactor fuel pellets for future reactor fuel. The remaining fission wastes, containing Cesium and Strontium, are then placed into containers and subsequently put into dry storage for the remainder of around 300 years, where most of the remaining half % of its radiation energy material, i.e., Cesium and Strontium decays. Thereafter this fission waste is put into a low level Class-C nuclear waste repository, which may include leaving them in the intermediate storage facility that is also designed to accommodate and dispose Class C waste.

### CROSS-REFERENCE TO RELATED APPLICATIONS

This application is a continuation-in-part of U.S. patent application Ser. No. 10/736,858, filed Dec. 16, 2003, entitled 300 Year Disposal Solution for Spent Nuclear Fuel, presently pending, which claimed the benefit of U.S. Provisional Patent Application Ser. No. 60/434,019, filed Dec. 16, 2002, expired.

### TECHNICAL FIELD

The invention relates to a method, process, and structure for utilizing a combination of 300 years of storage and five nines (99.999%) separation of the Transuranics from the Fission Wastes wherein processing disposes of spent nuclear fuel as MOX (mixed oxide) and fast burner reactor fuel and fission wastes are thereafter stored in a low level Class-C repository.

### BACKGROUND

For six decades, the question of how to dispose of spent nuclear fuel (SNF) has been a strangling problem to the nuclear electric generation industry, eventually curtailing its growth and, actually stopping the growth of the entire electric generation industry. Thirty years ago, three commercial reprocessing plants were built in the U.S.: General Electric's Midwest Fuel Recovery Plant at Morris, Ill.; the Allied General Nuclear Services (AGNS) plant at Barnwell, S.C., and the Nuclear Fuel Service's facility located near West Valley, N.Y. The NY plant was the only one of these private plants to process SNF. But for thirty years prior, since 1944, three DOE facilities in Idaho, South Carolina and Washington State did fuel reprocessing separating up to 99.5% of the actinides from the fission waste. Called the PUREX (plutonium, uranium, extraction) process, it was primarily developed at Argonne National Laboratory, Hanford and Oak Ridge. The process was later applied at INEEL, where development of head-end dissolution processes, and improvements in separations were subsequently made. The same solvent extraction PUREX technique has since been used by France, England, Sweden, Japan and Russia. Plants for chemical density floatation reprocessing are now being built in Australia and India. The separated uranium and plutonium components are made available for making new fuel but the disposal of the remaining fission and transuranic wastes still constitute a problem for disposal.

In the United States, President Carter and then President Ford stopped U.S. processing for fear that the components of the SNF would be used to make atomic weapons. Actually, old SNF is a poor source for weapons materials because in little time over 10% of the Pu239 advances to Pu240 and Pu241 this makes triggering very difficult, resulting in devices which fizzle. President Reagan subsequently ordered that U.S. electric utilities could again process their SNF, but since the huge losses resulting from President Carter's having required the utilities to dismantle their earlier plants, the utilities were reluctant to build processing facilities again, especially given the possibility that a new administration could again require dismantling of the newly constructed plants. This might be resolved if the Congress were to pay the nuclear utilities their prior invested and lost costs. This could be paid from waste disposal funds now being paid by the utilities with a stipulation that the repaid funds would be used to rebuild SNF processing.

As of today, the U.S. Congress being concerned for both the public safety from SNF and security from keeping SNF from wrong hands has elected to store away SNF in Yucca Mountain in Nev., for a long time. The U.S. Environmental Protection Agency (EPA) has stipulated a storage time of 10,000 years. The daughters of plutonium are ugly, so actually due to radioactive decay. In 10,000 years the SNF will be a much bigger radioactive hazard problem than it is today.

### Degree of Separation Considerations

By the PUREX process, until President Carter stopped SNF processing in the U.S. thirty years ago, the U.S. and other nations since processed SNF to 99.5% separation of the actinides (the transuranics plus the uranium) from the fission wastes. But this process leaves a fission waste component which contains too much transuranics remnant, so that until now the only known solution is geological burial.

Typical nuclear fuel which eventually becomes SNF is in the form of pellets around ⅜ inch diameter by ⅝ inch long. The pellets are securely sealed in zirconium fuel rods around 12 feet in length. A square matrix of fuel rods is held together in rack. This is the form in which they come from their use in an electricity power producing public utility reactor. The fuel rods are maintained in this form as they are stored vertically in a utility storage water pool. Rod assemblies are kept at least six feet under water. The water absorbs radioactive emissions and protects the workers of the facility from receiving radiation. The hot material in SNF is the fast decaying fission wastes. These radioactive wastes have varying half lives of typically less than 30 years. During the initial five years in utility pool storage, 99% of the fission waste energy is dissipated from the SNF. Another ½% of the waster energy goes during a following 50 years of dry convection, air cooled storage. Then most of the remaining ½% of the waster energy goes during 250 years of additional secure storage that can be either before processing or after processing after which the fission wastes can be encapsulated in a form of a vitrified glass capsule.

For dry storage, the fuel rod rack assemblies are put into five feet diameter canisters having, one-half inch thick stainless steel walls. This transfer of fuel rods from a rack storage to a canister is done under water in a utility storage pool. When a canister is being closed (shut, purged with inert gas, then sealed) it is raised so that the top end is out of the water. This permits workers to weld on a one-half inch thick stainless steel lid on the canister. The lid has additional radiation shielding to protect the workers as they attach the lid. The canister containing SNF/UNF (“used nuclear fuel”) is then purged of water, an inert gas is installed, slightly pressurizing the canister, then the canister is plug sealed closed. For the fifty years of intermediate dry storage, the canisters are typically put into concrete casks having typically two feet thick radiation shielding. An opening in the lower region or base of the cask allows convection cooling air to enter. A five-inch space between the outside wall of the canister and inside wall of the cask allows convection cooling air flow up over the wall of the canister. Openings in the top of the cask allow venting of the convection cooling air out. Ideally the cask and canister arrangement stands vertically.

Canisters in cask have been stored both vertically and horizontally. Horizontal storage has the advantage of minimizing the height of lifting requirement for fitting it into a storage cask. It is preferred (restricted by rules) that a canister be lifted no more than 18 inches above a surface upon which it may fall should the lift support fail. The 18-inch height limit is an NRC (Nuclear Regulatory Commission) rule. For circumstances of lifts higher than 18 inches of lift, a single failure allowable crane hoist system is used. The single failure crane hoist system is fitted with a redundant mechanical system which essentially provides a duplicate capability for critical operations, i.e., double lifting cable systems, double lifting drums and gear drives, and double brake systems. It is somewhat like a twin-engine aircraft. Should any one component fail, the system having that component will thus fail; however, since a second back up system exists, the second back up system will handle the canister or cask or canister in cask load.

There are concerns that above ground SNF storage cask systems typically now in use can be attacked with a TOW (Tank Ordnance Weapon) missile. It is feared that a TOW missile or a hijacked aircraft would penetrate a cask or canister unit, explode, and scatter the stored SNF.

### Reprocessing

In SNF/UNF the actinides and fission wastes are mostly a mixture of materials. They typically are not inter-connected with a chemical bond. There are compounds like Cs₂UO₄, where the bonds are broken by dissolution. To separate materials logical chemistry would require using liquid chemicals to put all the materials into solution from which they can then be separated by solvent extraction techniques. This process appears to create a substantial volume of chemicals which would probably be contaminated with various radioactive elements, so further operations would be required to clean up the solvents.

Relevant prior efforts in the area of reprocessing include those of Campbell et al.disclosed in U.S. Pat. No. 4,025,602. Campbell describes a spent nuclear fuel recovery process. The Campbell process achieves only a 99.5% separation of the actinides from the waste material. The Campbell process would recover only the trans-plutonium materials, meaning mostly the americium and curium, without the plutonium. Campbell does not appear to do or require the isolation of fission wastes, including cesium and strontium.

Campbell specifically indicates in his specification, that “irradiated fuel is periodically withdrawn from the reactor and reprocessed to remove fission and corrosion products and to recover uranium, plutonium and sometimes neptunium values.” Campbell furthermore indicates that “By ‘substantially free of actinides,’ it is meant less than about 0.1% by weight of the original actinide content.” Note that 0.1% by weight of the original actinide content is about equal to 1/10 the weight of all the plutonium in the spent nuclear fuel (SNF).

Assuming, arguendo, that Campbell were to achieve 99.999% removal of the plutonium by reprocessing removal of the actinides, to get the 99.999% of plutonium out, he would have to remove 99.99999 of the actinides (96% uranium plus 1% plutonium mix). But Campbell has indicated in his disclosure that his processing is “typical” of the PUREX 99.5% separation. Campbell certainly does not imply nor teach the especially high 99.999% degree separation of the transuranics from the fission waste, and particularly not the need to remove such high percentages of Cesium and Strontium from the waste. Although Strontium is mentioned in Campbell's patent, Campbell appears to make no mention of the need to remove Cesium from the waste material.

Campbell does not appear to teach or imply a 5-9's degree of separation of transuranics from the fission waste. Although Campbell provides for the recovery of trans-plutonium elements, adherence to the Campbell methodology results in much of the plutonium from the spent nuclear fuel likely remaining with the fission waste.

Following Campbell's disclosure in order to achieve a reprocessed spent nuclear fuel which is substantially free of actinides, the resultant fission wastes would include half of the plutonium from the original SNF. In the long-term plutonium decays to americium, which is a highly dangerous material. Short term SNF disposal and, more specifically, disposal of both cesium and strontium is not addressed by Campbell. It would appear that Campbell's recovery method for SNF uranium (actinides) is probably limited to extracting uranium from the SNF to be used as new fuel. The Campbell process does not appear to be directed to processing SNF in an effort to permanently dispose of that SNF. Instead, Campbell deals with the trans-plutonium, where as Peterson instead deals directly with the plutonium. The instant process removes the plutonium, thereby removing the source for the problem causing trans-plutonium, which is markedly different from the process of Campbell.

### Heat Unloading of SNF

Being directed primarily to the extraction of uranium from SNF, Campbell does not appear to address the problem of cooling the resultant products of a SNF reprocessing method. The deposition of SNF in Yucca Mountain in its unprocessed form will create a massive cooling problem. It is presently contemplated that storage of SNF at Yucca Mountain (YM) will require 10,000 HP (horsepower) of convective air cooling for 50 years, in order to maintain a facility temperature which is below the boiling temperature of water.

### A Solution for SNF is Needed

In the U.S. 103 nuclear power plants produce over 20% of our nations electricity need. Fossil fuels are waning and there is a need to make hydrogen to replace use of gasoline and diesel, for use to power cars and trucks. To make electricity, to do electrolysis of water, to separate water H2O into hydrogen and oxygen, it is estimated that by the middle of the 21^{st} century, the U.S. will need 515 additional nuclear power plants. An additional 400 new power plants will be needed to replace the coal generating utilities. However, before the utilities can proceed with building new plants, a solution for SNF must be found and implemented. The U.S. Congress has approved Yucca Mountain for 10,000 years of geological storage of the SNF; but, this is not a permanent solution as SNF is 97% potential fuel that eventually will be needed unless the world can find another solution for making power.

The only solution the utilities now have for SNF is onsite temporary storage in canisters in concrete casks, stored above ground on concrete pads.

### SUMMARY OF THE INVENTION

To get the SNF off the utility sites, to dispose of the SNF, a method is proposed wherein the SNF is first stored for five years or more in utility pools. Then fuel rods in bundles are transferred into steel canisters. These canisters are put into shipping casks and hauled to an intermediate storage facility having provisions for convention air cooling, and configured to store the SNF, in canisters, in concrete casks, and sufficiently underground to have protection from theft and today's terrorist threats of TOW missile' attack and aircraft attack. From this intermediate storage, the SNF is at some time taken to a processing facility having facilities to separate five nines or 99.999% of the transuranic material from the fission wastes, such that the residual fission product waste forms have less than 100 nCi/g contamination of transuranics as defined in 10 CFR 61 for low level wastes. The objective of this processing is the removal of more of the actinides from the SNF. In embodiment of the invention, the SNF is repeatedly subjected to processing utilizing the PUREX process. After an initial processing of the SNF, the once processed SNF is processed again, separating out 99.5% of the actinides remaining after the first processing resulting in 0.5% of actinides remaining in the SNF, and leaving only 0.0025% of the original actinides with the fission wastes. Then by processing the SNF yet again thereby separating out 99.5% of the actinides remaining in the 0.0025% from the original component, what theoretically remains with the fission wastes is now only 0.0000125%, hence achieving a 99.9999975% separation.

The PUREX process, as used for the past 50+ years, would likely achieve a separation in the first pass of 99.9%, a more difficult second processing might be only 98%, and a third possibly only 90%, given the difficulties in repeated iterations of the processing. Alternatively, in another embodiment of the process the UREX process may be utilized to achieve the necessary separations in unit operations for specific elements, as is further considered herein.

The separated components resultant from the processing are returned to intermediate storage until the uranium and plutonium component can be taken to a facility and made into MOX fuel which can then eventually be used in a reactor as fuel, and the fission waste component is stored a total of 300 years so that it is decayed sufficiently so it can be put into a low level Class-C waste disposal facility. Materials put into a Class-C facility are monitored for 100 years. After that time no further oversight is required. The proposed intermediate storage facility might be designed to the specs for a Class-C repository. Then, after 300 years, the 300-year intermediate storage facility can go on to serve as a Class-C waste disposal facility for indefinite future storage and entombment.

In general, as in most all matter, like our human bodies, for example, contain some amount of radioactive material. Note that coal contains uranium so that when it is burned, smoke carries uranium to plants, which when consumed by cattle, consumed as meat and dairy by humans, so this uranium gets into all human bodies to a degree, so to a degree fission wastes can remain containing some uranium etc. Similarly, all nuclear fuel contains some degree of fission wastes, more and more as actinides are used as fuel. So it is reasonable that some fission waste could be in the new MOX fuel. In fact, to make fuel from SNF more difficult to handle for security purposed, it may even be desirable to keep some of the fission waste with the separated uranium, plutonium etc. So the inventor views that five nines is not necessarily a hard number, to better enable processing, and to achieve other possibly desirable attributes. Once again, the five nines separation of TRU's from fission products is essential to enable the fps (fission products) to be disposed as LLW (low level wastes). This does not mean five nines separation of fps from Uranium (“U”) and TRUs. (transuranic wastes)

### BRIEF DESCRIPTION OF THE DRAWINGS

FIG. 1 (including FIG. 1a, FIG. 1b, FIG. 1c, FIG. 1d and FIG. 1e) is a block diagram showing the 300-year disposal method for UNF or SNF, showing the intermediate storage solutions to all UNF disposition paths. Activities are shown in three periods of time. Water cooling and shielding utility pool storage is shown happening in the first five years after the UNF is removed from service from a utility reactor. In the balance of fifty years after service, the UNF is confined in convection air, dry storage. However, during this time, the UNF can be classified and staged for processing, even manufacturer of fuel rods and convection cooled storage of fission wastes if processing should be done during this fifty-year period. Processing might more easily be done after fifty years of fission waste decay. Processing could even wait until after 300 years when the isolated fission wastes can be classified as low-level Class-C wastes. Anytime after the processing the actinides and transuranic can be made into MOX fuel, used in a reactor, then cycled back through the UNF disposal process. Note that it may be useful to leave some of the fission wastes with the new fuel, and it might not be much of a problem to leave some of the potential fuel with the fission wastes. Again, this could be true for U but not for Pu, and the other TRUs.

FIG. 2 is a schematic drawing tracing the SNF and its components from when it is removed from reactor use to water storage for five years, intermediate convection air cooled storage for 50 years, 250 years of more storage for the fission wastes to loose last ½% of decay energy, processing, separation making the actinides available for new fuel, putting the fission wastes into a low level Class-C disposal facility.

FIG. 3 (including FIG. 3a, FIG. 3b, FIG. 3c, FIG. 3d and FIG. 3e) is a drawing of an intermediate storage site showing a system of parallel railroad tracks servicing the area of the field, showing a gantry crane for off loading, showing a transfer table making access to the parallel railroad tracks, showing an earthen berm shielding and protecting the field, and showing railroad trackage to and from a canister transfer facility.

FIG. 4 (including FIG. 4a, FIG. 4b, FIG. 4c, FIG. 4d and FIG., 4e) is a drawing of a row of subsurface casks showing contained canisters in the path of convection air provided by an air-duct underneath getting outside cool air down through a vertical shaft. To show the idea, the underground duct is shown rotated 90 degrees. A gantry crane and railroad delivery car shows how canisters are brought into and taken out of the storage field.

FIG. 5 is an illustration showing at a most penetrating angle how an aircraft might impact on a canister container subsurface cask. Note the method of transfer of the momentum of the fast flying light weight constructed aircraft to the dense concrete cap, cask inlet, and surrounding earth. Then the momentum of the much lower velocity concrete cap is transferred to the massive intermediate plug, which would move down with considerable difficulty, then push the fuel rod containing canister down into the space of the air passageway, likely not even puncturing the canister and very doubtfully breaching a fuel rod, and

FIG. 6 is a schematic diagram illustrating the processing of spent nuclear fuel into a number of resultant components and the subsequent disposition of those components.

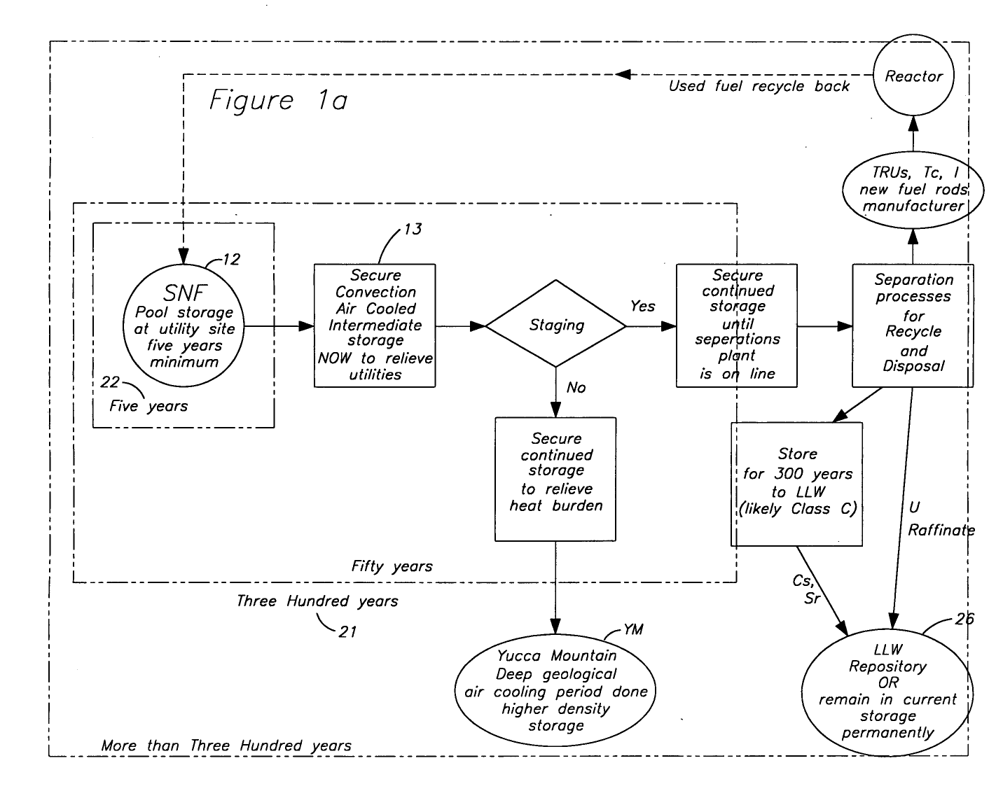

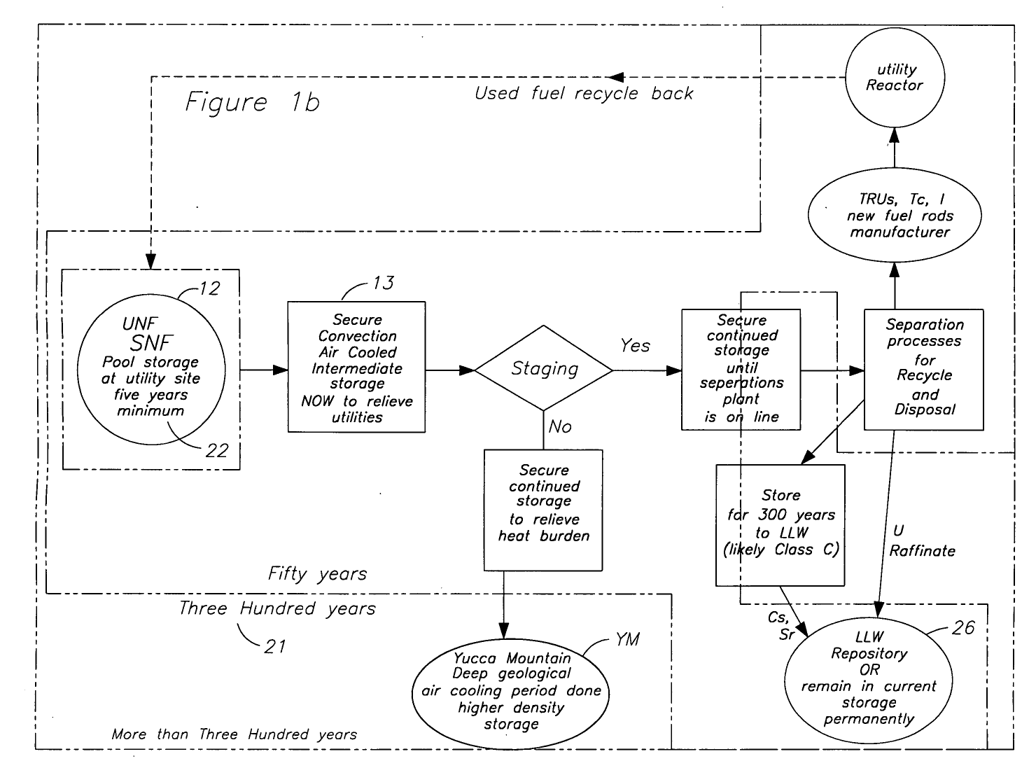

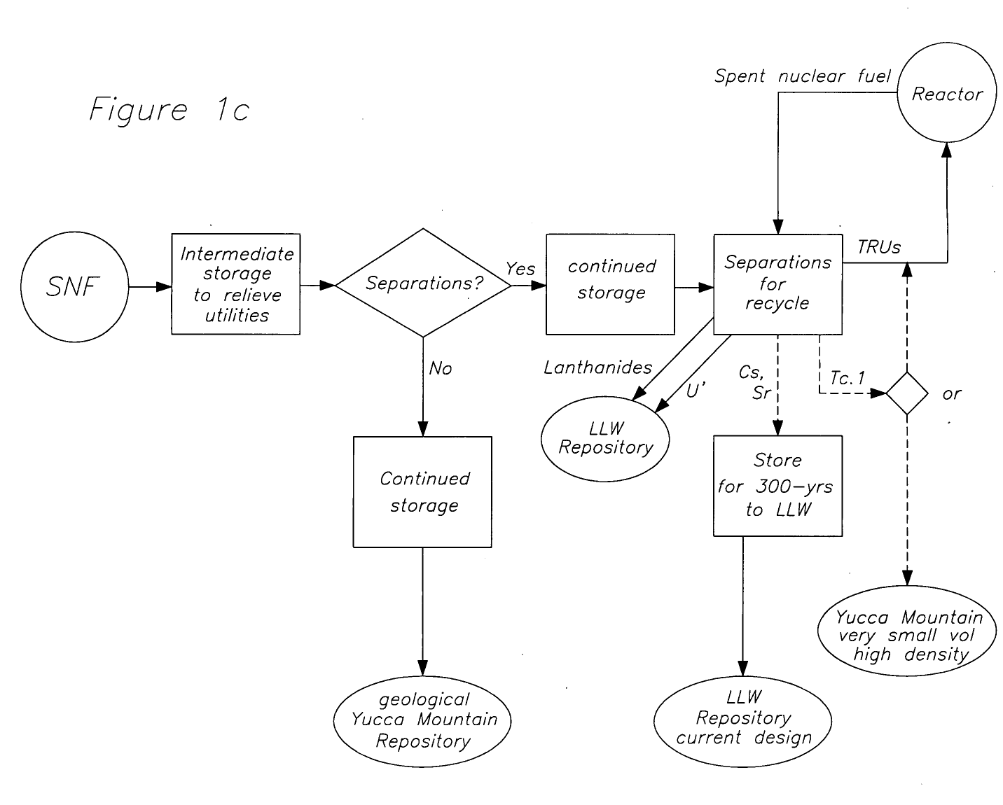

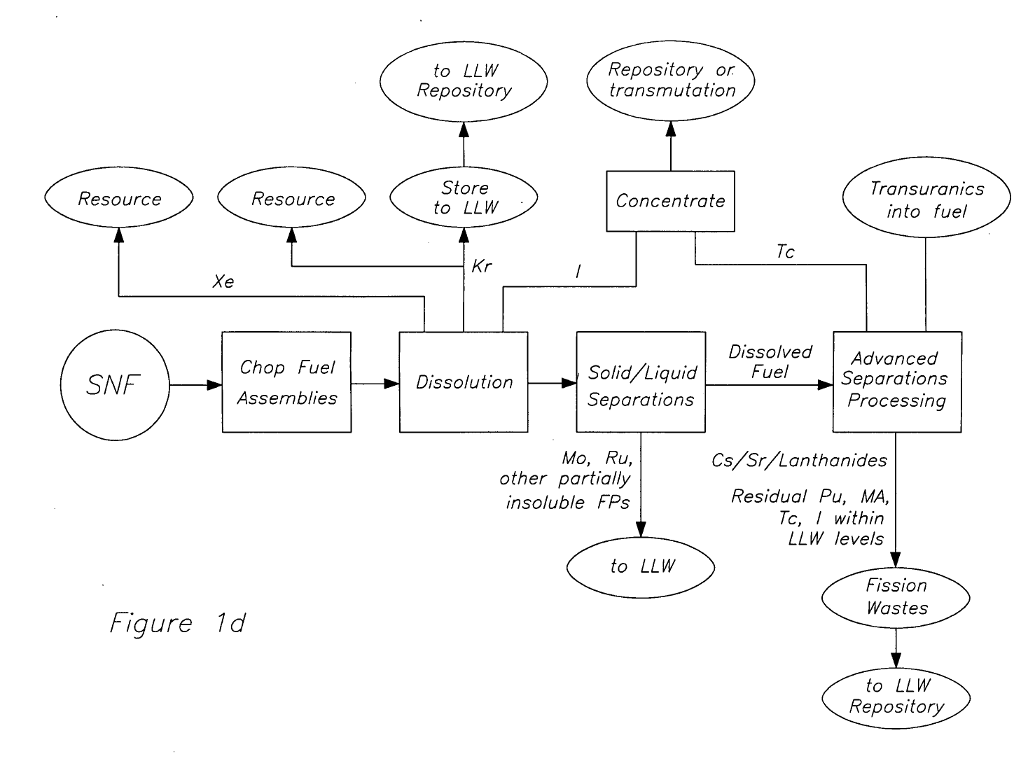

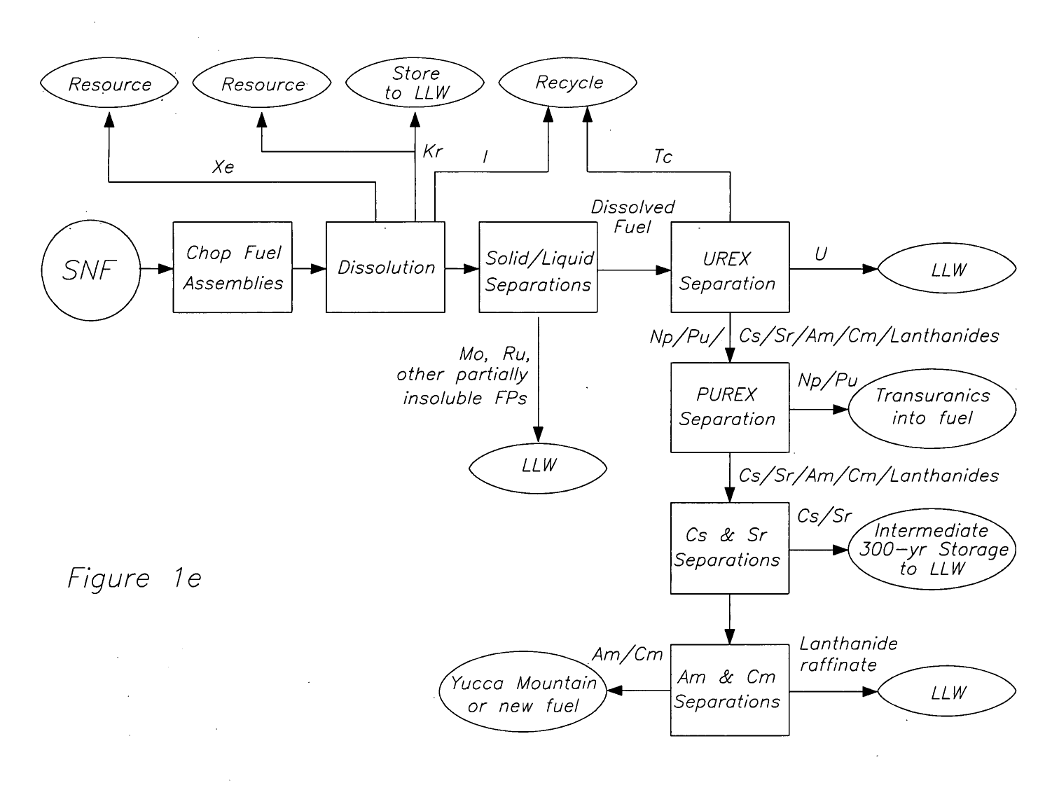

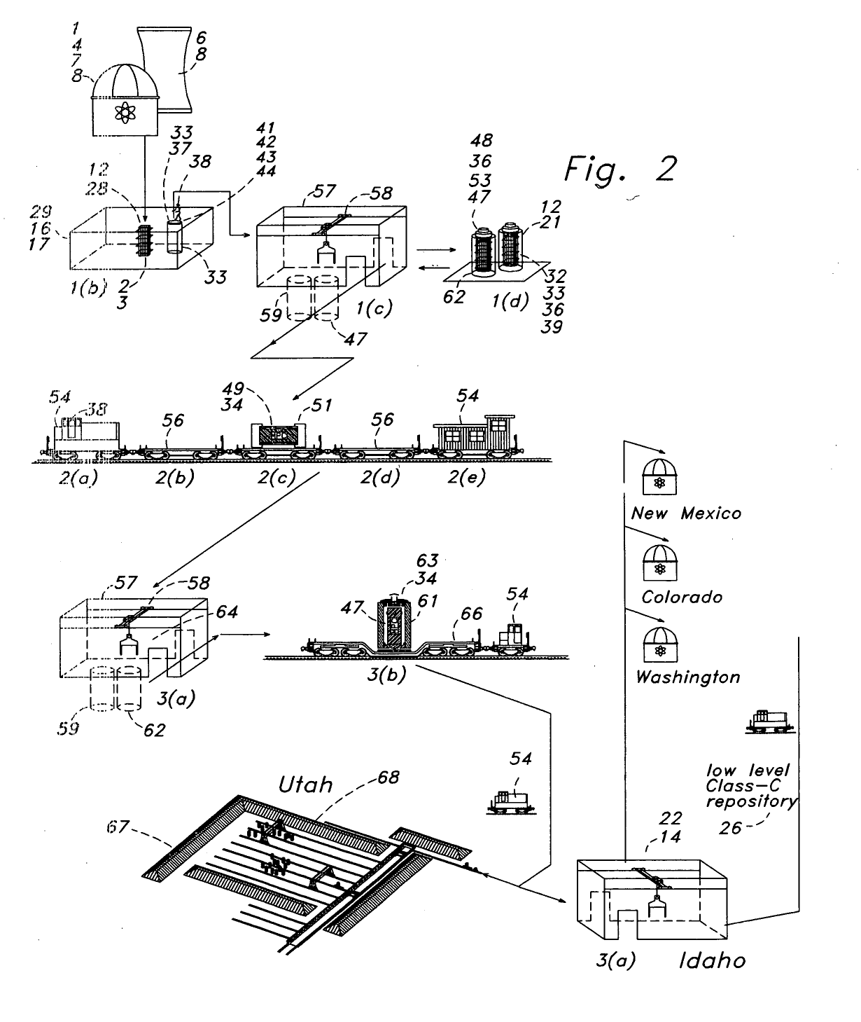

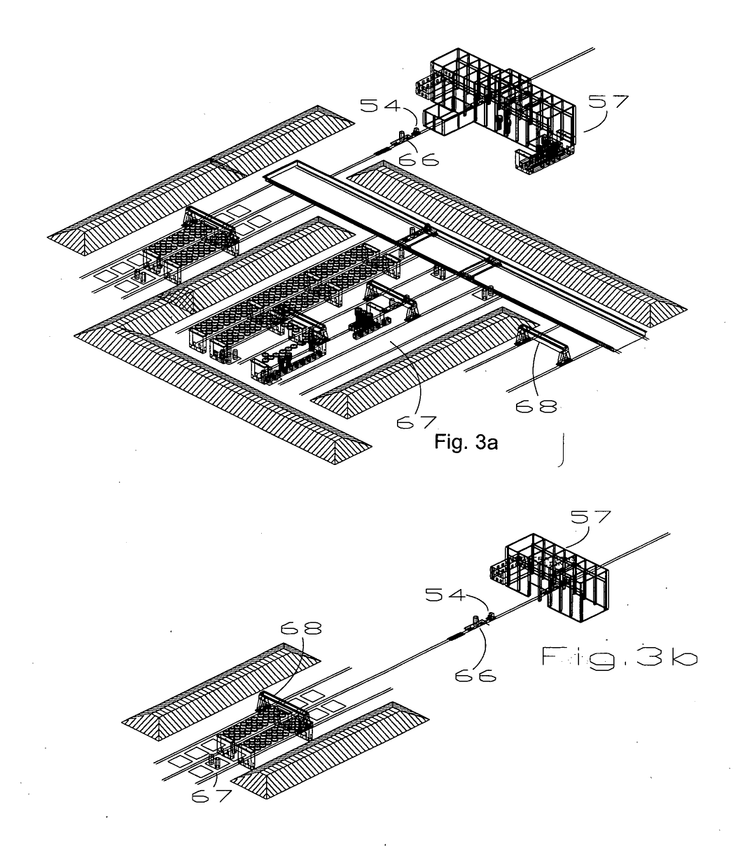

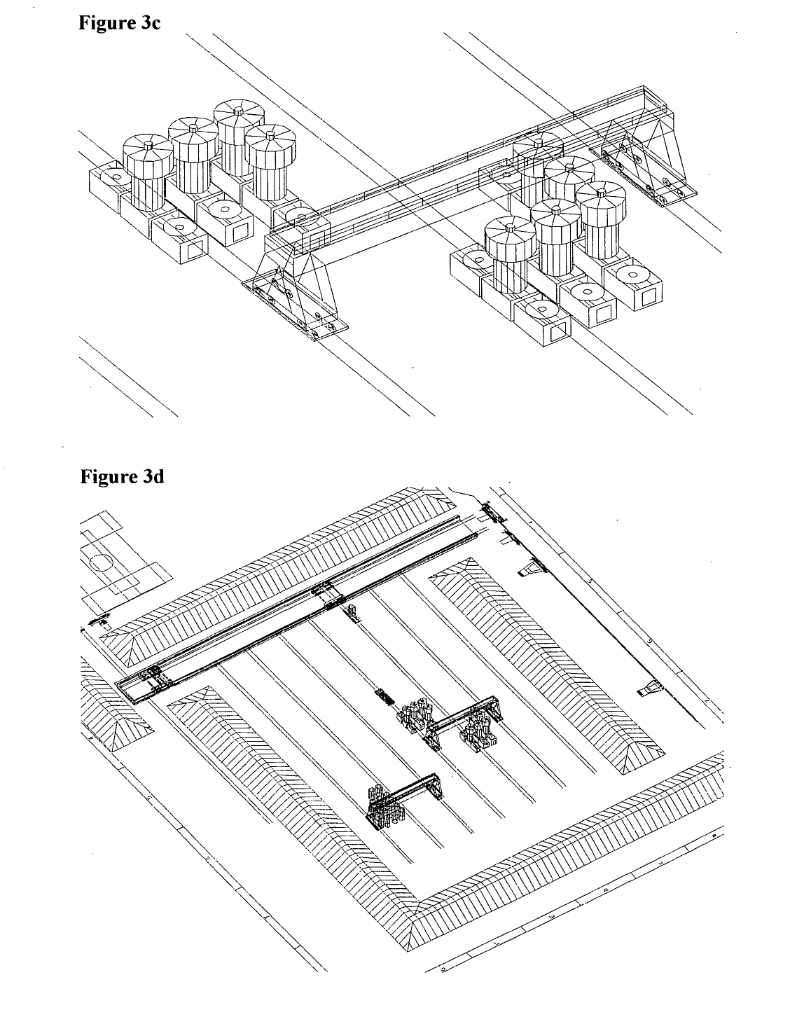

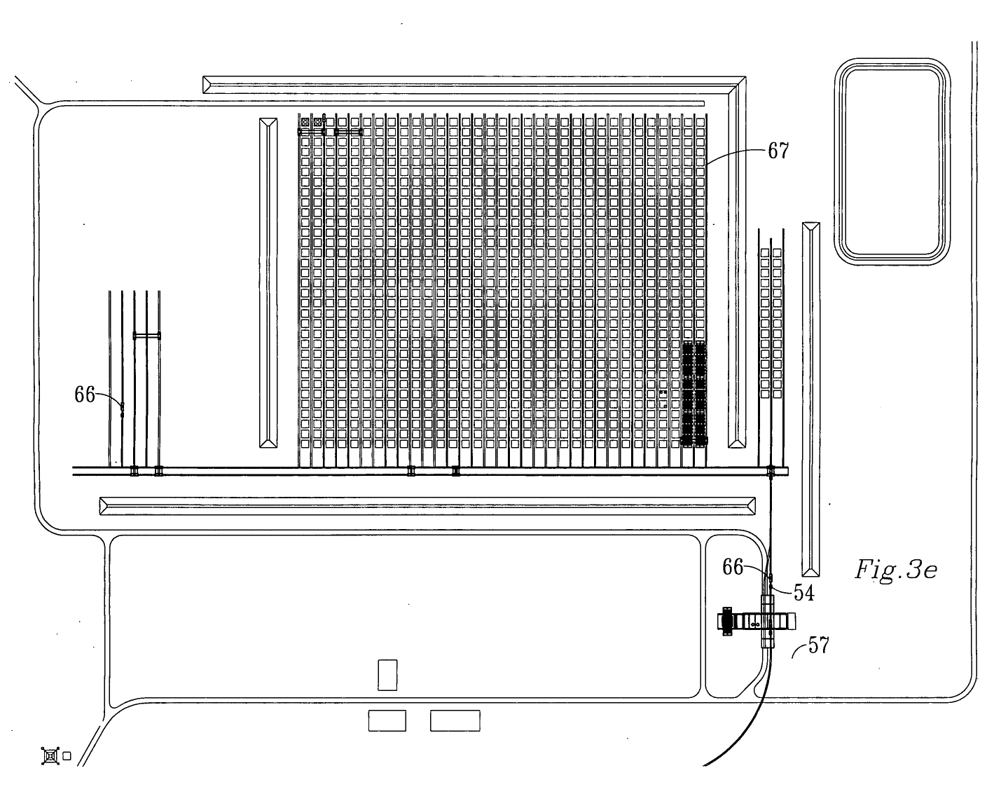

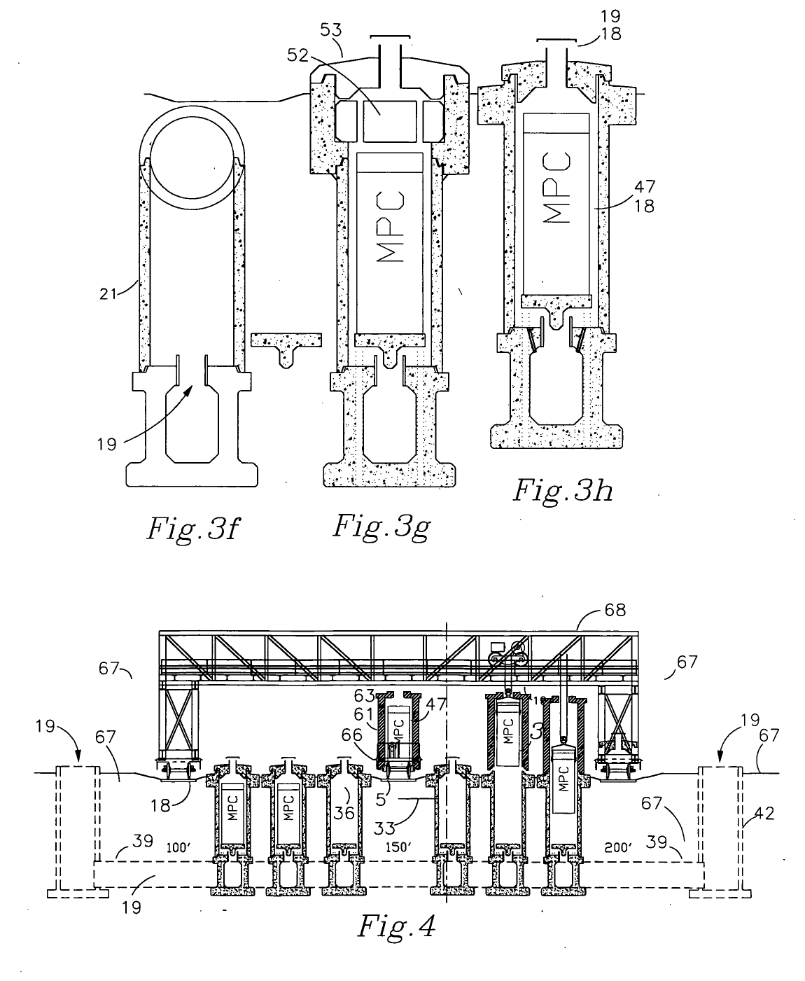

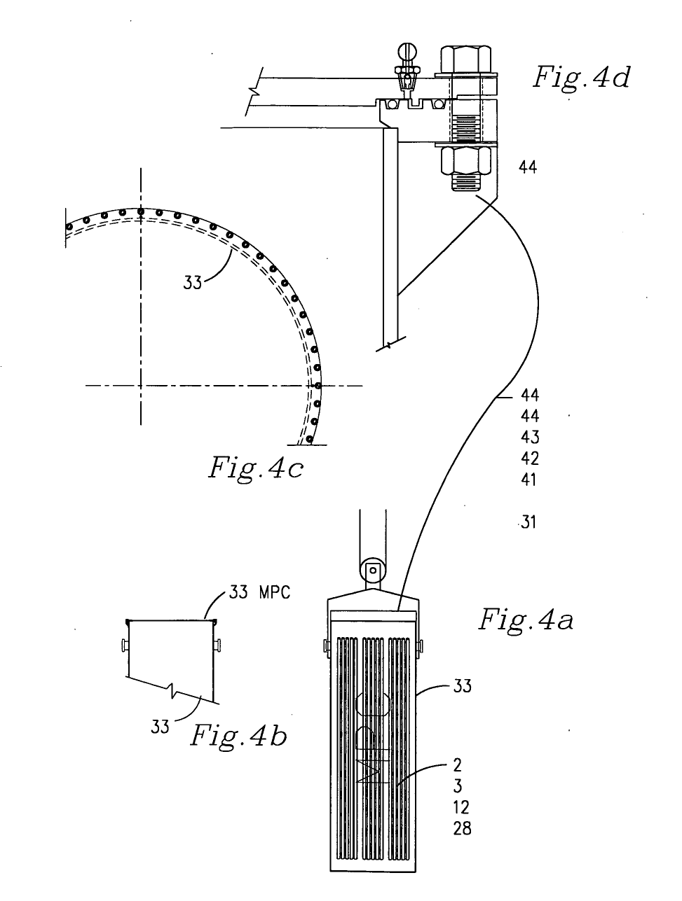

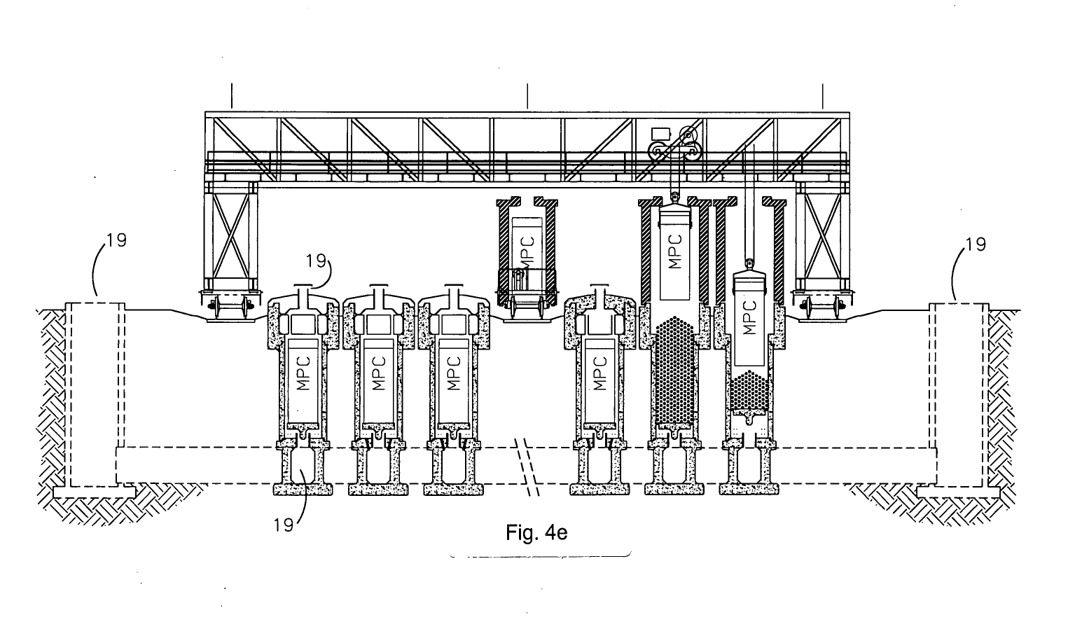

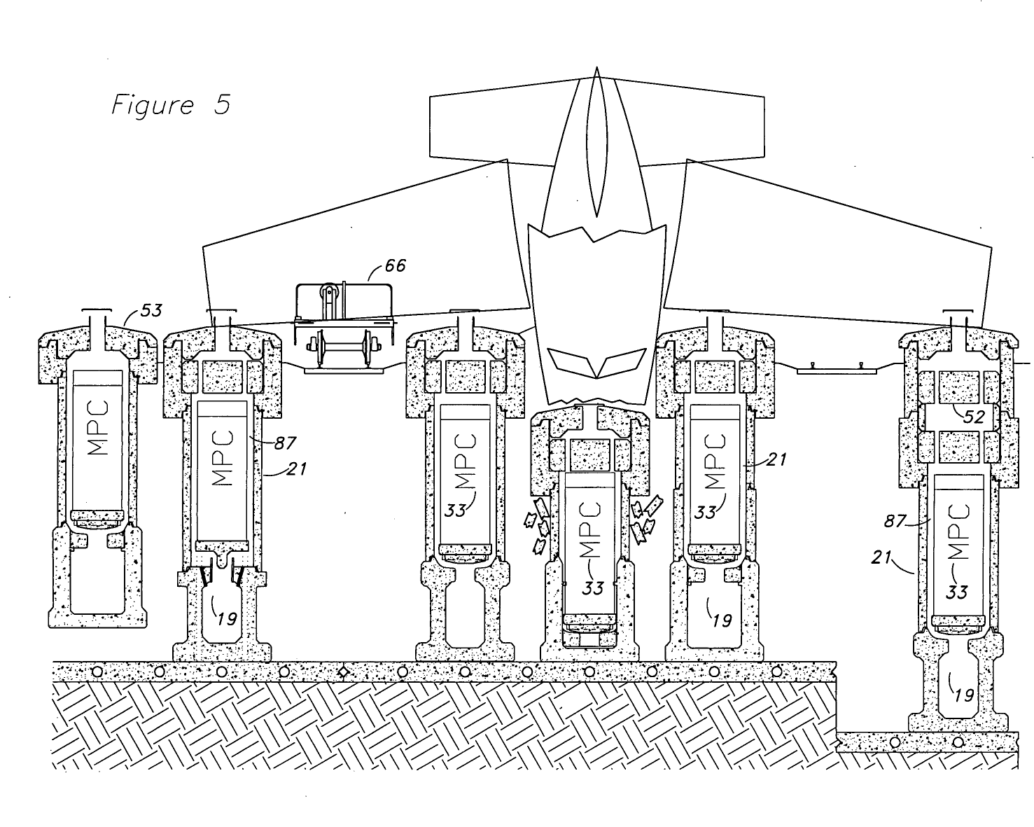

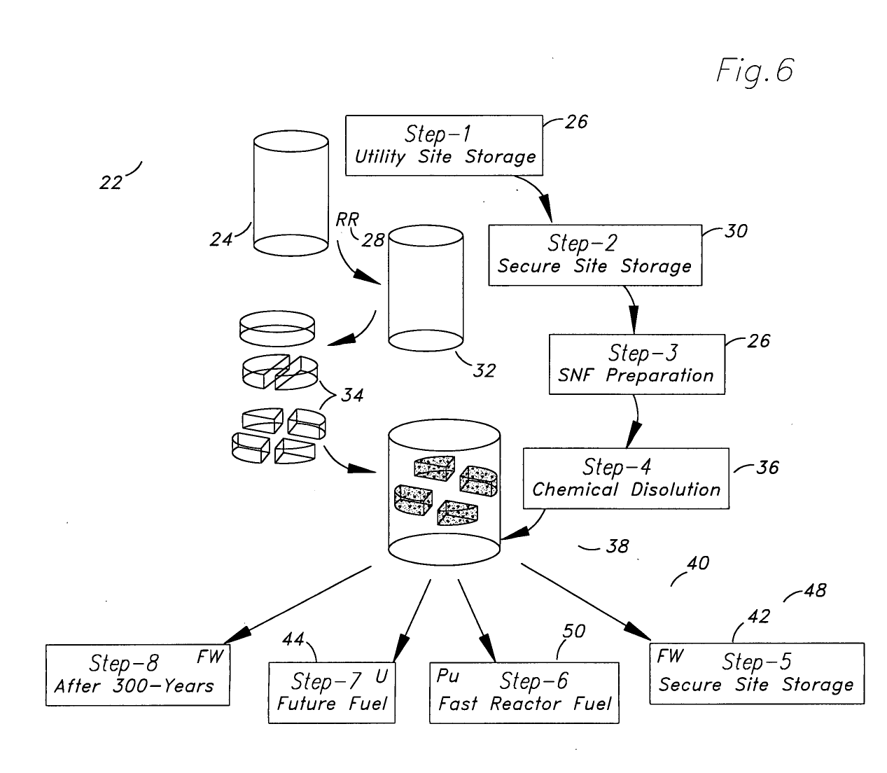

### DETAILED DESCRIPTION OF THE INVENTION

Nuclear fuel material 1 consisting primarily of a mixture of uranium U235, U238, and plutonium Pu239, housed in fuel rods 2, combined in bundles 3, is used to make heat 4 to make steam 6 to make electricity 7 in utility nuclear reactors 8. During operation, fission wastes 9 are made in the fuel 1. Then at some time after use of the fuel 1, due to corrupting waste 9, the initial fuel 1 must be replaced with new clean fuel 11. The removed used nuclear fuel is also called spent nuclear fuel 12. What to do with spent nuclear fuel 12 has been a problem to the nuclear generation industries 8 since nuclear power 7 was first made a half century ago.

The instant invention contemplates a method of processing the SNF whereby by a combination of intermediate storage 13 and reprocessing 14 spent nuclear fuel (SNF) 12 is effectively disposed of in a period between 300 and 1000 years.

In the U.S., 20% of the nation's electricity 17 is made at 103 nuclear power plants 27. To do this nuclear reactor fuel 1 is made up of uranium pellets which are approximately ⅜ inch in diameter and ⅝ inch long. Around 250 pellets are housed in individual sealed alloy metal fuel rods 2 which are approximately one-half inch in diameter and 12 feet long. Each fuel rod 2 is closed by a seal weld. The fuel rods are subsequently placed into a reactor in bundles 3 formed of 12×12 (12 dozen) fuel rods 2, grouped together in racks 28. After a time of service in the nuclear reactor the fuel becomes corrupted (SNF 12) and in turn becomes incapable of efficiently producing energy 7. When the fuel 1 becomes spent 12 the fuel rods 2 are removed from the reactor 8 and are quickly put into a water pool storage 16. Although the fuel rods have been removed from the reactor they are still producing energy at this point in time. The energy which is released by these fuel rods is subsequently absorbed by the cooling water 27 within the water pool storage 16. The energy released by the fuel rods, in the form of heat 17, declines exponentially approximately 99% over the following five years.

The instant method contemplates an initial five or more years of pool water storage 16 in which ninety-nine percent (%) of the fission waste material is permitted to decay. During the course of this storage the material is cooled by the water surrounding the material. The material may then be further cooled before it is processed to separate the Cesium and Strontium. This subsequent cooling is done in convection air cooled concrete casks 21. It is contemplated that this subsequent cooling operation will continue for a period of substantially 50 years in order to obtain a reduction of another half percent (%) decay in the waste material. After the five years of water storage, the heat release or production from the fuel rods is sufficiently reduced, such that the fuel rods can be removed and further cooled by a convection air 33 process. In dry storage 29 the fuel rods 6 are typically stored in bundles 3 which are held in racks 28 which in turn are retained in sealed 31 storage canisters 32.

The instant invention contemplates the use of a multipurpose configuration (MPC 33) canister which can be used both for initially shipping the SNF rods from the nuclear reactor site to the water storage site. These canisters are used for both shipping 34 packs and storage 36 packs. For the 300-year disposal system, the storage canister is better constructed with opening and closing with mechanical fasteners using a seal system such as an O-ring seal system, rather than being welded closed, as is now being done. With an open able and serviceable seal system the canister would be equipped for more easy pressure testing and better supportive pressurizing and alterations to overcome minor leakage that may occur. For seal enhancement the seal system has means to be immersed in liquid to seal against, which liquid may be added, so in cases where the mechanical seal deteriorates and partially or wholly loses its/their ability to seal, the canister is still capable for low pressure (approaching zero) sealable from a circulation of outside air.

At first, a stored canister is purged and filled with an inert gas. Then, in time, even if the internal pressure goes to zero, as long as the canister remains filled with the inert gas and oxygen does not get in, corrosion cannot occur. To maintain this isolation, the open able 50-year canister system will have means for a liquid fallible seal system (between) coupled with the mechanical (O-ring) seal system, so in case of near zero pressure liquid may be added to insure that the interior is sealed. As such, after 50 years of use (typical use before processing), it might be possible to use the same canister again for newer SNF for its initial 50 years of intermediate storage.

Note that this seal system is somewhat similar to the seal system proposed for the Challenger rocket motor problem, that is two seals, also pressurized between, pressure monitored between, when that pressure fails, a liquid is inserted in the between, which liquid has sealing and isolating capabilities. Note that the canister and its interior are constructed with stainless steel or similar non-corrosive materials. For the 300-year process, a period of use for a canister use is specific for only 50 years. This compares to the 10,000-year Yucca storage process where the attempt is to have a storage canister system capable of lasting 10,000 years. However, for the 300-year process, the canister, casks, and storage site will be designed for 300 years of use, and then for even longer use for the indefinite length of time Class-C low level storage.

The current design for MPCs 33 has cylindrical canister walls of one-half inch thick alloy steel and the same for a flat bottom and flat top. In addition to the one-half inch thick plate top, the top has lead shielding 37 to protect workers 38 closing the MPC 33. Typically the canisters 31 are sealed welded closed, then are purged, filled and pressurized with an inert gas 3973. Canister 3157 for the 300-year solution 14 will use a seal 31 at the top of the canister 33. For a more secure seal 31 the seal closure system will be at least a double O-ring 41 with a space between 42 which can take a pressurized liquid 43 or other fluid which would create a blockage between the two O-rings 41.

Note also that while the main thrust of the 300-year disposal solution is related to burning the separated actinides, if the policy of the country is not to do that, the separated actinides, which have only a tiny fraction of the mass, volume, and heat load of fission products and SNF, could be disposed in a mini-Yucca Mountain, or would avoid the need for a future second, third, etc., Yucca Mountain. Although the transuranics have a small initial heat load relative to Cs and Sr, it is their long-term heat generation that ultimately limits the density of loading in YM.

The intermediate storage cask system would have means and be equipped to daily monitor the convection cooling temperature, monthly monitor for radiation leakage, a sign of cask deterioration, and semi-annually check the canister internal pressure. Where problems are detected, the system would have a capability to clean convection air passages, means for repairing deteriorating casks, and means to fix canister leaks and/or re-pressurize canisters.

A storage system for the separated fission wastes will keep the fissions wastes, possibly in vitrified form, contained for 250 years. It may be desirable to use a fission waste container system, which is may be opened and serviceable like the canister for the SNF. Otherwise the fission wastes might be vitrified in glass, which would keep materials all contain as a solid block, or possibly in smaller units like briquettes or pellets. This would at least put the fission wastes in a system that would not dissolve should its storage be invaded with water. In the 250 years of this material storage, only ½% of the original heat capability will still be contained in the fission wastes material so little or no particular cooling system is likely required. The ½% heat generation conditions during the 250 years of storage of the isolated fission waste are compared to the 99% dissipated of heat in the first five years, and the ½% dissipated in the next 50 years.

In three hundred years, the resulting aged and reduced fission waste material will be unique. During this 250-year storage time, it is likely that beneficial uses, particularly in fields of medication will probably be found. It would probably be desirable to do the 250 years of storage of fission wastes having the material contained in a form that would allow the aged nuclear material to be recovered for other uses.

The MPC 33 loading procedure of installing bundles 3 of fuel 1 rods 2 is done in the storage water 29 pool 16. The top lid is positioned just out of the pool 16 water 29 for the workers 38 to secure weld on the lid. The combined shielding of the water 29 and the lead shielding 37 of the lid make safe the conditions of closure of the MPC 33. The gas 39 pressurization of the MPC 33 displaces the water in the canister 33, which came in from the pool water 29 during the SNF 12 canister 32 loading operation. Since the 300-year process 14 requires the canisters 32 to eventually be opened and the SNF 12 processed 13, the 300-year procedure 14 uses a unique bolted seal system 44 instead of welding.

The MPC 33 is designed to be used upright. Two foot (2′) thick concrete cask 46 are designed for convection air 47 passage entering the bottom of the cask 36 then escaping out of the top 48. Concrete casks 36 open via a top lid 48 at an elevation of around fourteen feet (14′) to sixteen feet (16′). Intermediate storage shipping casks 49 are constructed of metal combinations including lead and are lighter in weight (80 tons). A typical above ground combination storage canister 31 and cask configuration 36 weighs 130 ton. Shipping casks 34 are loaded and unloaded while standing vertical but are laid horizontal for shipping, with massive impact absorbers 51 attached. NRC requires that MPCs 33 and casks 23 containing an MPC 33 are not lifted more than eighteen inches (18″) above a surface onto which it may fall. An exception has had to be made for the vertical transfer operations described above where historically as much as 18 feet lifts are now required.

For adequately secure storage, the 300-years canister storage is subsurface in a dry pool system, stored in the earth, but near enough to the surface to still enable convection air cooling (see inventor's U.S. Pat. No. 5,862,195 which is incorporated herein by reference in its entirety). This method of storage slightly below the earth's surface has new options of both a concrete cap and an additional three feet thick concrete plug above the canister so the storage system cannot be penetrated with a TOW missile or crashing aircraft. An underground air duct system provides a way for ambient surface air to go down vertical shafts, go horizontal under the stored casks, and then convecting up between the exterior walls of the canisters and the inside walls of the storage silos. The air ducting is sufficiently short and open to enable natural convection cooling without a need to fan power pump the cooling air.

The intermediate storage casks are fitted between rows of railroad trackage such that a gantry crane can lift a cask containing canister or a shielded canister from a rail car and lower the canister assembly into a storage silo (see inventor's U.S. Pat. No. 5,448,604 which is incorporated herein in its entirety). Vertically standing shipping casks are used to shield the area from radiation. The bottom of the shipping casks are open so that canisters in casks lifted from a rail car can be placed over an open storage silo and then lowered from the shipping cask into the storage silo without ever exposing the atmosphere to radiation. A field gantry bridge crane system having single component failure capability does the lifting for field placement and retrieval requirements.

A canister in a cask as an intermediate storage unit typically weighs around 130 tons. For shipping, a lighter weight unit package typically weighs around 80 tons. For shipping, instead of concrete, a shipping cask is made of layers of metals.

There is an ongoing ever escalating material handing problem for 300 years. The initial large radiation problem declines exponentially. The degree of processing will need to be further considered. After consideration, when to process the SNF is determined by compromise. In 300 years of scientific and technological development, overcoming the radiation hazards potential to minimizing the massive material handling situations will likely make processing again and again sooner prevail.

In the 300-year disposal operation at the monitored retrievable storage “MRS” 61, MPC 33 canisters 32 of SNF 12 arrive by RR train 54 on a flat bed RR car 56. Shipping casks 34 containing an MPC 33 arrive in the transfer building 57. A large capacity (special single failure) bridge crane 58 (150 ton capacity) picks the loaded shipping cask 34, picking it at one end so that it stands vertically. The bridge crane 58 then carries the loaded shipping cask 34 around a wall maze 64 of radiation shielding walls 64 in the transfer building 57, and lowers the MPC 33 unit into a transfer pit 59 prepared to receive the shipping cask 34 containing an MPC 33. The canister 33 is removed from the transfer pit 59 with the bridge crane 58, then lowered into a concrete storage cask 36 or field delivery cask 63 in an adjacent transfer pit 62.

A bridge crane 58 is then used pick and carry the loaded field storage cask (or transfer cask) 61 then carries the loaded storage cask unit 36 back to a special site use railroad car 66. This railroad car 66 is a special extra low bed railroad car adapting for transport in the MRS storage field 67. The railroad car for carrying the MPC bearing storage cask is a modified low bed double drop type 66 typically known as a transformer car, but for this use is modified to be even lower. This minimizes the potential to tip over, of a vertical standing storage cask unit 36.

Once the unit 36 is ready to be stored, it is hauled by rail 66 to the storage field 67. A field gantry crane 68 is used to pick up and place the transfer cask 61. The shielded canister 32 and the loaded cask 36 is carried to a storage location 67 and from this the canister 32 is lowered into a field 67 storage cask 69. For even more secure storage, a concrete momentum transfer plug 52 is installed over the placed canister 33. Then a cask lid 53 is set above the mass momentum absorption plug 52. The lid cask lid 53 has a manifold for convection air 19 out and is covered with segments of granite slabs 53 for thousands of years of endurance.

An MPC's 33 removal from the storage field 67 is done in the reverse order of how it arrived. A unit 36 being removed is hauled by rail out of the MRS (Monitored Retrievable Storage field 67), transferred from a field storage cask 69 to a shipping cask 34 then removed by rail.

To enable this storage procedure MPC canisters 33 are sealed with a double seal 41 and secured with a bolted on lid 44. The seal system is uniquely configured with liquid submersible seals 41 so that in instances of failure, seals 41 will otherwise seal MPC 33 so the canisters will remain sealed. The MPC 33 contains an inert gas 39 during the 300-year disposal process. If needed, additional inert gas 39 can be added so that fuel rods 2 in an MPC 33 always remain protected from corrosion.

At any point during the air convection storage phase, the SNF is removed from storage and then repeatedly processed using the PUREX process in order to remove 99.999% of transuranics resident in the SNF. Again, Class C limits only address transuranics, not uranium (an actinide)]. Approximately 95% U238 uranium, 1% U235 uranium, and 1% Pu239 plutonium are removed from the 3% fission wastes 9. In order to achieve the desired separation factors the waste material may be subjected to repeated processing utilizing the process described in LAB-SCALE DEMONSTRATION OF THE UREX +2 PROCESS USING SPENT FUEL, C. Pereira, G. F. Vandegrift, M. C. Regalbuto, S. Aase, Al Bakel, D. Bowers, J. P. Byrnes, M. A. Clark, J. W. Emery, J. R. Falkenberg, A. V. Gelis, L. Hafenrichter, R. Leonard, K. J. Quigley, Y. Tsai, M. H. Vander Pol, and J. J. Laidler, Argonne National Laboratory, Waste Management '05 Conference, Feb. 27-Mar. 3, 2005, Tucson, Ariz., the contents of which are hereby incorporated by reference in their entirety.

Note that some percentage of fission wastes in the actinides if eventually used as new fuel might be tolerable, or maybe even desirable. For safe health this hotter fuel may then require special handling considerations which might be desirable to improve security, require special handling in a theft situation. Fuel being used in a nuclear reactor will always contain some amount of fission waste; being, as they are being generated by the nuclear process. For the sake of a place to start, 0.5% fission wastes in the new fuel would be tolerable (one part in 200), this ⅛ of the fission wastes in the SNF/UNF (used nuclear fuel) before reprocessing. Saying it another way, we might tolerate removing only 80% of the fission wastes SNF/UNF then using these actinides plus contamination of ⅛ of the fission wastes for new fuel. Of the 4.0% fission wastes when fuel is retired to SNF/UNF 0.5% is a little over 1/10 of the fission wastes in the original SNF/UNF. Said another way, we might tolerate only 87% clean up of the fission wastes from the actinides. It is an idea that might be considered.

Considering the other side, taking an exception to the Class-C requirements some residual of the 96% part of SNF that is uranium left in the fission wastes might be found to actually not be much of a problem, but is maybe only a tolerable loss of potential fuel. With a remnant of uranium the fission waste can still meet the Class C requirement of getting the fps to <100 nCi/g TRUs, so in 300 years the fission waste can be disposed of a low level Class-C. For comparison, Utah coal contains uranium which when the coal is burned is a loss of potential nuclear power. Some amount of uranium is virtually in everything. For argument, at some point it may be reasoned that it is more costly to recover and use the potential fuel than simply wasting a little of it. For example, it might be deliberated that a process yielding fission waste having 1% actinides and 0.03% transuranics might be justifiably accepted. This would be a waste of around ⅓% (0.003) of the potential actinide fuel in the SNF/UNF going into reprocessing. Looking at this in another way, if this concept of reprocessing would prove to be less costly than 10,000-year storage, then a 99½% savings of actinide energy in the SNF/UNF would be an extremely attractive bonus. Such fission wastes would reduce volume and could be more compactly stored in Yucca Mountain.

Note that over time the around 3% part of SNF that is fission wastes destructs into inert matter. As inert matter, this 3% fission waste part could eventually be part of the 96% part of the SNF that is uranium potential fuel. So there is a consideration that fission waste might eventually be a part with the uranium potential fuel. Then it becomes a matter of how much inert material can be carried with potential fuel. If only 4% of the original uranium and plutonium is used as fuel, the remaining 94% is simply inert material. Actually, only around 1% of the original uranium and plutonium is used as fuel, so 99% is inert matter. The point here is some part of the processed fission waste could be in the uranium potential fuel, and be recycled.

The separated actinides 1 and transuranics are then utilized to fabricate MOX (mixed oxide) fuel pellets 22, using conventional methods, for future reactor fuel 1. The remaining fission wastes 9, i.e., those containing Cesium and Strontium are then placed in containers and put into dry storage 13 for a period of up to 300 years. Subjecting these remaining fission wastes to this period of storage results in the remaining half percent (%) of the radioactive decay of the Cesium and Strontium found in that waste material. Having reached this level of decay the waste material is now at a sufficiently low radioactive level that it will meet the current requirements for disposal as low level Class-C nuclear waste. In one embodiment of the invention the proposed interim storage 13 could be designed to the specifications for a Class C repository 26 so that after 250-300 years, the waste 9 could be left indefinitely without further intervention.

Anytime after the five years of pool storage the SNF can be processed and separated into actinides and fission wastes. Some consideration of the problems made by the radiation from the associated fission wastes may determine when the SNF is best reprocessed for separation. A unique point in the 300-year disposal process occurs after 50 years of intermediate storage, because at that point, it is considered that convective cooling of the SNF is no longer required, as 99.5% of the heat generating ability is dissipated. Actually, at some point in technology development, it may be determined that reprocessing might best be ideally done immediately after pool storage; or, it may be determined that reprocessing might ideally be done after 300 years. When MOX fuel (mixed oxide fuel) is made with the actinides will weigh largely on when the SNF is processed. Note that SNF actinides have half-lives typically longer than 10,000 years, in contrast to the fission wastes, which have half lives typically shorter than 30 years. The other determining factor is associated with heat being generated by the fission wastes, the first 99% being absorbed by water in the plant pool storage system, the next ½% being absorbed by air in convection air cooled storage, and the last ½% simply transferred to adjacent concrete and earth which conveys the heat to the surrounding ground and atmosphere above.

In all what is accomplished is that the 97% of SNF or UNF is put back into use as eventual fuel and the 3% of fission wastes is stored for a sufficient amount of time that the typically 30 years and shorter half life high radiation energy matter is sufficiently decayed (reduced a 1000 fold) so that the remains fission can safely be put away in a Class-C low level waste storage facility, and so, the SNF or UNF is disposed of. The inventor considers there are reasons that some of the fission wastes might well be left with the separated out actinides, and some of the actinides might be OK be left with the fission wastes. The whole idea is to get the fps to <100 nCi/g TRUs, so in 300 years they will be Class C for permanent disposal. The principal objective is that the SNF or UNF is disposed of in 300 years and is not left to be a problem for ultimate disposal out to 10,000 years and beyond.

The modeling by Wigeland et al. of ANL shows that after a first recycle as MOX fuel, all future recycles of TRUs must be to a fast burner reactor to destroy them.

While the above description contains many specific details as to construction of the invention, it should be appreciated that the invention is subject to many modifications, and is therefore, accordingly the full and true scope of the invention should be determined only by the appended claims and their legal equivalents.

What is claimed is:

1. A method of disposing of spent nuclear fuel containing transuranics Cesium and Strontium, said method comprising:
removing said spent nuclear fuel from a nuclear reactor;
placing said spent nuclear fuel into water storage for at least a period of five years;
thereafter placing said spent nuclear fuel into a convection air cooled concrete shielded storage, withdrawing heat from said spent nuclear fuel as said fuel decays and storing said spent nuclear fuel in said storage until at least fifty years have elapsed from the date of said removal of said spent nuclear fuel from said nuclear reactor;
thereafter placing said spent nuclear fuel into a shielded storage and retaining said spent nuclear fuel in said shielded storage until at least 300 years have elapsed since the removal of said spent nuclear fuel from said nuclear reactor;
wherein said spent nuclear fuel is processed, subsequent to its being stored in said water storage for at least five years, to remove at least 99.999% of the transuranics from said spent nuclear fuel, said processed spent nuclear fuel thereafter being retained in storage for a subsequent 100 years and thereafter being disposed of; said transuranics, being removed from said spent nuclear fuel and subsequently being utilized to produce new nuclear fuel.

2. The method of claim 1, wherein said storage at said convection air cooled concrete shielded storage and said storage at said shielded storage are effected at a same facility.

3. The method of claim 1, wherein said spent nuclear fuel is subjected to multiple processings in order to achieve higher percentages of separation of said actinides from said spent nuclear fuel.

4. A process for physically disposing of spent nuclear fuel (SNF) containing transuranics, Cesium, Strontium, and fission wastes, said process comprising:
removing spent nuclear fuel from a nuclear reactor;
placing said spent nuclear fuel into water storage for at least five years to remove heat generated by a decay of the components of said SNF, principally heat generated by Cesium and Strontium contained within said SNF;
placing said spent nuclear fuel into convection air cooled concrete shielded storage until at least fifty (50) years has lapsed since said spent nuclear fuel was removed from said nuclear reactor to unload heat from a decay of said components within said SNF;
placing said spent nuclear fuel into shielded storage until at least three hundred (300) years has lapsed since said spent nuclear fuel was removed from said nuclear reactor at anytime after removing said spent nuclear fuel from said water pool storage, processing said spent nuclear fuel to separate the transuranics from the spent nuclear fuel.

5. The process of claim 1, wherein said processing comprises a solvent extraction dissolution process.

6. The process of claim 5, wherein said processing is repeated a number of times until said desired 99.999 per cent of transuranics have been removed from said spent nuclear fuel.

7. An apparatus for storing and processing spent nuclear fuel comprising:
a means to shield and remove spent nuclear fuel from use in a nuclear reactor;
means for promptly transporting said spent nuclear fuel to a pool of water;
means of holding said spent nuclear fuel submerged in said pool of water while cooling and cleaning said water;
a means to house, shield and transport said spent nuclear fuel from said pool of water to a system of convection air cooled storage;
a means to house, shield and store said spent nuclear fuel in an inert atmosphere for up to 50 years after removed from reactor use;
a means to securely house and shield the spent nuclear fuel after the 50 year term of the convection air cooled storage, for 300 years after removal from its use in a nuclear reactor;
a means for processing of the spent nuclear fuel to separate transuranics therefrom until separation in the range of 99.999% separation is achieved;
means for storing the actinides until said transuranics can be processed to make new nuclear fuel; and
means for confining and storing fission waste components of said processed nuclear fuel where the fission wastes are confined and stored after 300 years after removal from nuclear reactor use for 100 years and on, indefinitely without further intervention.

8. The apparatus of claim 7, wherein said spent nuclear fuel is contained within canisters having bolt on lids with a double lid seal, said canisters having provision to pressurize the canisters with inert gas and pressurize between the double lid seal; said canisters further having provisions to routinely measure the canister interior pressure and the pressure between the double lid seal; and further having provision to insert a barrier between the double seal in instances where the seal system is detected as failing.

9. The apparatus of claim 8, wherein the inserted barrier is a liquid.

10. The apparatus of claim 7, and further having an intermediate storage subsurface and having an underground air manifold system with ducting from the ambient atmosphere for cooling, the ducting to enabling outside air to enter the underground air manifold system and rise by convection over the canister exterior, conveying radiation heat away and maintaining temperature equilibrium of the spent nuclear fuel.

11. The apparatus of claim 7, and further including a gantry crane wherein the storage field is serviced by said gantry crane which travels on railroad rails, spanning a set of railroad rails which carries a canister hauling car into or out of the storage field for delivery, placement, retrieval, and carrying out of spent nuclear fuel in canisters housed in protective casks.

12. The apparatus of claim 11, and further including a transfer table system to enable the gantry crane and a delivery train to index to other tracks.

13. The apparatus of claim 11, further including a protective, shielding, and concealing berm around the storage field which both obscures the storage field from view and also, shrouds the storage field from attack.

14. A system for disposal of spent nuclear fuel comprising:
a pool storage for five years;
a convection air cooled storage for fifty years;
means to process the spent nuclear fuel to obtain 99.999% separation of transuranics from fission wastes contained within said spent nuclear fuel, means for storing said fission wastes or unprocessed SNF for at least 300 years;
means for storing said fission wastes after 300 years; and
means to manufacture new nuclear fuel from said transuranics separated from said fission wastes.

15. The apparatus of claim 7, further including means for processing said transuranics to produce plutonium from any uranium within said transuranics.

16. The apparatus of claim 7, further including means for multiple processing of said spent nuclear fuel and further having means for monitoring condition of said spent nuclear fuel during storage, having means to qualify SNF for an optimal situation for reprocessing, having means to select and remove spent nuclear fuel from storage deemed to be best suited (qualified) for reprocessing.

17. The apparatus of claim 12, and further including an intermediate storage means wherein after 250-300 years, the fission waste could be left indefinitely without further intervention.

18. The process of claim 3, further including the step of enriching the actinide with plutonium, the enrichment plutonium being first processed to make some portion of said plutonium an oxide chemical, and changing the density of said enriched transuranic material such that it no longer may be used to make a critical mass.

19. The system of claim 14, further comprising means to bind a mixed oxide material into cylindrical pellets which can be inserted and sealed in reactor fuel rods.

20. The process of claim 3, further comprising additional processing of said processed spent nuclear fuel after 300 years of storage to separate out remnant transuranics.

21. A method for permanently disposing of spent nuclear fuel comprising:
separating substantially all of the transuranics from any fission wastes resident in said spent nuclear fuel;
incorporating said transuranics into fuel for a nuclear reactor;
storing said fission wastes for a sufficient time to permit their decay to a condition which may be introduced into the environment without hazardous results.

22. The method of claim 21, wherein said separation is effected sufficiently to achieve a 99.999 per cent separation of said transuranics from said fission wastes.

23. The method of claim 22, wherein said fission wastes are stored for a period of time at last three hundred years of monitored storage and thereafter for a period of at least one hundred years of secure storage.

24. The method of claim 23, wherein uranium contained within said fission wastes is stored and eventually removed from said fission wastes and thereafter used to manufacture new fuel for a nuclear reactor.

25. The process of claim 1, wherein heat is withdrawn from said spent nuclear fuel as said fuel decays in said water storage.

26. The process of claim 1, wherein heat is withdrawn from said spent nuclear fuel as said fuel decays in said convection air cooled concrete shielded storage.

27. The process of claim 26, further including isolating a source of said heat, namely said Cesium and said Strontium, from said spent nuclear fuel.
